(19) United States
(12) Patent Application Publication
(10) Pub. No.: US 2004/0141559 A1
(43) Pub. Date: Jul. 22, 2004

(54) Generating UWB-OFDM signal using sigma-delta modulator

(76) Inventors: Ahmed H. Tewfik, Edina, MN (US); Ebrahim Saberinia, St. Paul, MN (US)

Correspondence Address: Schwegman, Lundberg, Woessner & Kluth, P.A., P.O. Box 2938, Minneapolis, MN, 55402, US

(21) Appl. No.: 10/693,651

(22) Filed: Oct. 24, 2003

Related U.S. Application Data
(60) Provisional application No. 60/420,832, filed on Oct. 24, 2002.

(51) Int. Cl. H04B 14/06

(52) U.S. Cl. 375/248

(57) ABSTRACT

High-bit rate communication system for networking computing systems are described. The system uses a hybrid ultra-wideband orthogonal frequency division-multiplexing scheme. The transmitted signals are sparse pulse trains modulated by a frequency selected from a properly designed set of frequencies. The train itself consists of frequency modulated ultra-wide pulses. Sigma-Delta modulation is used in some implementations. Additionally, pilots can be transmitted over some subcarriers to demodulate an information bearing subcarrier. The system achieves good detection by integrating several pulses, and high throughput by transmitting frequencies in parallel. Unlike traditional orthogonal frequency division-multiplexing systems, a given tone is transmitted only during parts of the transmission interval.

### RELATED FILES

This application is related to U.S. patent application Ser. No. 10/191,769, entitled “HIGH BIT RATE ULTRA-WIDEBAND OFDM”, filed on Jul. 8, 2002; U.S. Provisional Patent Application entitled “Generating UWB-OFDM Signal using Sigma-Delta Modulator” (Attorney Docket 600.608PRV) filed on even data herewith; and claims the benefit of U.S. Provisional Application No. 60/420,832, filed Oct. 24, 2002, all of which are hereby incorporated herein by reference for all purposes.

### STATEMENT OF GOVERNMENT RIGHTS

This invention was made in part with a grant from the Government of the United States of America (award no. 9979443 from the National Science Foundation). The Government may have certain rights in the invention.

### FIELD

The present invention relates generally to wireless communications, and more particularly to generating and receiving high bit rate ultra-wideband orthogonal frequency division multiplexed (UWB-OFDM) communications using Sigma-Delta Modulation and pilots transmitted over some subcarriers of the UWB-OFDM system.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2002-2003, Regents of the University of Minnesota, All Rights Reserved.

### BACKGROUND

Ultra-wideband (UWB) typically transmits ultra-low power radio signals with very short electrical pulses, often in the picosecond (1/1000th of a nanosecond) range, across many frequencies at once. UWB communication systems typically use signals with a fractional bandwidth that is larger than 25% of the center frequency, or more than 1.5 GHz. Several UWB communications schemes have been proposed. These systems typically use pulse-amplitude or pulse position modulation and different pulse generation methods, pulse rate and shape, center frequency and bandwidth. Most of these systems generate and radiate the impulse response of a wideband microwave antenna and use that response as their basic pulse shape. Some systems utilize careful baseband pulse shaping and RF modulation techniques to control the center frequency and bandwidth of the radiated pulses.

UWB communication systems offer several potential advantages. For example, the wide bandwidth of such systems generally makes them more robust to multipath interference. Further, the fine time resolution of UWB systems makes them good candidate for ranging applications. Indeed, much of the earlier work in UWB systems occurred in the radar field. Recognizing the potential benefits of UWB systems, the FCC has opened up the 3.1-10.6 GHz to indoor UWB transmission subject to power limitations.

Earlier UWB systems were designed to be carrierless. Since the FCC allocated the spectrum 3.1-10.6 GHz for UWB, these systems must be revised to satisfy the FCC power spectral density mask. All previous time-domain UWB systems have typically been single carrier. This complicates the design of such systems to fit FCC regulations and makes inefficient use of the available spectrum

Orthogonal frequency division multiplexing (OFDM) is a multi-carrier transmission technique that uses orthogonal subcarriers to transmit information within an available spectrum. Because the subcarriers may be orthogonal to one another, they may be spaced much more closely together within the available spectrum than, for example, the individual channels in a conventional frequency division multiplexing (FDM) system.

While UWB and OFDM each provide benefits for wireless communications, the data rates achieved by these systems has been inadequate for many purposes. For example, data rates of less than 100 Mb/s that have been reported so far by UWB systems and aggregate rates of less than 800 Mb/s for existing orthogonal frequency division-multiplexing OFDM schemes. As a result, there is a need in the art for the present invention.

### BRIEF DESCRIPTION OF THE DRAWINGS

FIG. 1 is a block diagram of a UWB-OFDM transmitter according to embodiments of the invention;

FIG. 2 is a block diagram of a sigma-delta modulator;

FIG. 3 is a block diagram of an N-Tone Sigma-Delta Modulator according to embodiments of the invention;

FIG. 4 is a graph illustrating a frequency response of a quantization noise filter;

FIGS. 5A-5B are block diagrams illustrating N-Tone Sigma-Delta UWB-OFDM transmitters according to embodiments of the invention; and

FIGS. 6A-6C are block diagrams illustrating N-Tone Sigma-Delta UWB-OFDM receivers according to embodiments of the invention.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

In the Figures, the same reference number is used throughout to refer to an identical component which appears in multiple Figures. Signals and connections may be referred to by the same reference number or label, and the actual meaning will be clear from its use in the context of the description.

The following detailed description is, therefore, not to be taken in a limiting sense, and the scope of the present invention is defined only by the appended claims.

The detailed description comprises multiple sections. In the first section, a description of UWB-OFDM is provided. In the second section, In the second section, Sigma-Delta UWB-OFDM transmitters according to various embodiments of the invention are described. In the third section, Sigma-Delta UWB-OFDM receivers according to various embodiments of the invention are described. In the fourth section, performance of embodiments of Sigma-Delta UWB-OFDB systems is discussed. In the last section, a conclusion is provided.

### UWB-OFDM System

In some embodiments, UWB-OFDM operates by splitting orthogonal sub-carriers in a train of short pulses, sending them over the channel and reassembling them at the receiver to get orthogonality and recover each sub-carrier data separately. Unlike narrowband OFDM, a given tone in UWB-OFDM is transmitted only during parts of the transmission interval. Reliable communication results from integrating several pulses, and high throughput from transmitting frequencies in parallel. One of the differences between UWB-OFDM and narrowband OFDM is their spectral shapes.

UWB-OFDM is based on the properties of frequency coded pulse trains. A frequency coded pulse train may be defined as follows:

$$p ( t ) = {\sum }_{n = 0}^{N - 1} s ( t - nT ) {ⅇ}^{- j \frac{2 πc ( n ) t}{{T}_{c}}} \qquad ( 1 )$$

where s(t) is a unit energy square pulse with duration Ts and p(t) consist of N of these pulses shifted by T. Note that Ts<T and p(t) has duration Ts=NT. Each pulse is modulated with a frequency c(n)/Tc where c(n) is a permutation of the integers {0,1, . . . , N−1}. If c(n) is a Costas sequence, p(t) is near-optimal for multi-carrier UWB signaling. Additionally, the signals fₖ(t)=p(t)e^{j2πkf}^{₀}^{t}, k=0,1, . . . ,N−1 are orthogonal for fo=1/(NT). These orthogonal sub-carriers can be modulated with any digital data stream (e.g. off keying, BPSK and QAM). In the M-QAM embodiments of the UWB-OFDM system, the transmitted signal has the following form:

$$x ( t ) = β {\sum }_{k = 0}^{N - 1} b ( k ) p ( t - {rT}_{t} ) {ⅇ}^{j2π {kf}_{0} ( t - {rT}_{t} )} \qquad ( 2 )$$

where b(k)=bᵢ(k)+jb_{q}(k) is a M-array QAM symbol. Parameter β is a constant determines the average transmitted power.

It is useful below to write p(t) as

$$p ( t ) = \underbrace{[ {\sum }_{n = 0}^{N - 1} s ( t - nT ) ]}_{p ( t )} \underbrace{[ {\sum }_{n = 0}^{N - 1} {ⅇ}^{- j \frac{2 πc ( n ) t}{{T}_{c}}} {Π}_{T} ( t - nT ) ]}_{m ( t )} , \qquad ( 3 )$$

where Π_{T}(t) is a rectangular pulse of with support [0, T].

Further details on UWB-OFDM signals may be found in U.S. patent application Ser. No. 10/191,769, entitled “HIGH BIT RATE ULTRA-WIDEBAND OFDM” which has been previously incorporated by reference.

Unlike narrowband OFDM, the UWB-OFDM spectrum can have gaps between subcarriers. A modified sigma-delta modulator, referred to as an N-Tone sigma-delta modulator, introduces N zeros at the frequencies in the quantization noise spectrum. These zeros may match the locations of frequencies used by the OFDM system and the quantization noise spectrum fills the gaps in the spectrum of the UWB-OFDM signal. In fact this new structure may be used in other UWB systems anytime there are gaps in the spectrum of transmitted signal.

Like narrowband OFDM, It is desirable to accomplish modulation and demodulation process digitally in the base band. Designing such a transmitter and receiver for UWB-OFDM signal typically requires fast and high-resolution digital-to-analog (D/A) and analog-to-digital (A/D) converters that operate on a very large frequency band. The modified N-Tone sigma-delta modulator may be used for this purpose. This novel structure introduces N zeros at N properly selected frequencies in the quantization noise spectrum and may be used anytime there are gaps in the spectrum of the transmitted signal. A digital transmitter and receiver for UWB-OFDM signal is described below.

### Digital UWB-OFDM Transmitter

Since analog circuit technology has improved at a much slower rate than digital technology, it is desirable to perform the bulk of the processing load involved in implementing signal presented by equation (2) using digital technology. An approximation to the transmitted signal in equation (2) by replacing p(t) from equation (1):

$$x ( t ) = β {\sum }_{k = 0}^{N - 1} b ( k ) {\sum }_{n = 0}^{N - 1} {ⅇ}^{- j \frac{2 πc ( n ) t}{{T}_{c}}} s ( t - nT ) {ⅇ}^{j \frac{2 π kt}{NT} .} \qquad ( 4 )$$

Since

$${f}_{0} ⪡ \frac{1}{{T}_{s}}$$

then the following approximation can be used:

$$s ( t - nT ) {ⅇ}^{j \frac{2 π kt}{NT}} \approx s ( t - nT ) {ⅇ}^{j \frac{2 π nk}{N}} \qquad ( 5 )$$

and then the UWB-OFDM signal can be approximated by:

$$x ( t ) \approx β {\sum }_{k = 0}^{N - 1} b ( k ) {\sum }_{n = 0}^{N - 1} {ⅇ}^{j \frac{2 π kn}{N}} s ( t - nT ) {ⅇ}^{- j \frac{2 π c ( n ) t}{{T}_{c}}} . \qquad ( 6 )$$

The transmitted signal then is:

$${x}_{t} ( t ) = β {\sum }_{k = 0}^{N - 1} {\sum }_{n = 0}^{N - 1} s ( t - nT ) \{ {b}_{i} ( k ) cos ( 2 π ( {f}_{c} \frac{c ( n )}{{T}_{c}} ) t + \frac{2 π kn}{K} ) - {b}_{q} ( k ) sin ( 2 π ( {f}_{c} \frac{c ( n )}{{T}_{c}} ) t + \frac{2 π kn}{K} ) \} \qquad ( 7 )$$

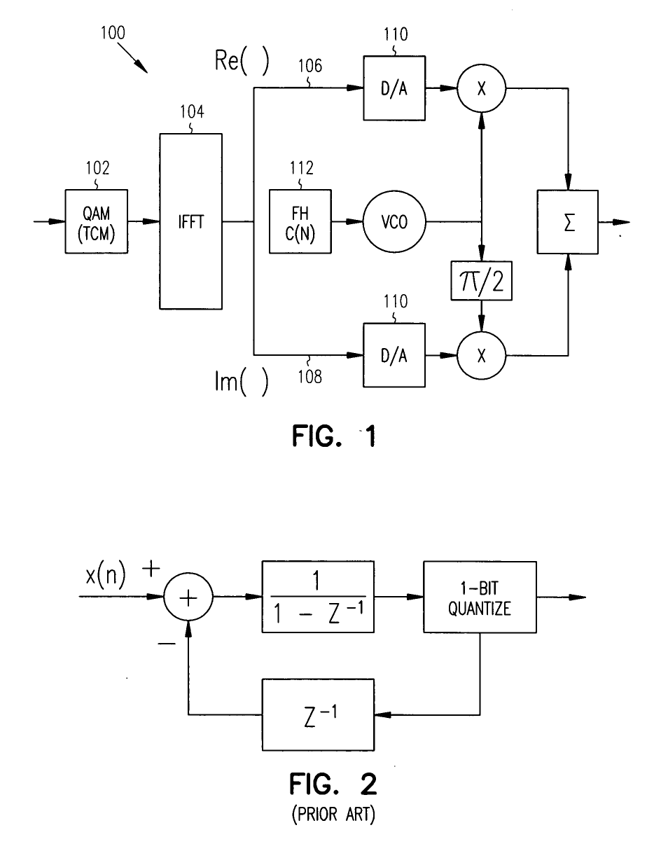

FIG. 1 illustrates as transmitter structure 100 according to embodiments of the invention that may be used to generate the signal in the equation (7). A stream of equiprobable QAM symbols 102 modulates N digital frequency using IFFT (Inverse Fast Fourier Transform) 104. Real and imaginary parts (106 and 108) of digitally modulated signal then pass through a D/A 110 and transfer to carrier frequency in an RF section. In some embodiments, a frequency hopping encoder 112 codes a transmitted pulse train with Costas sequence by hopping the carrier frequency between frequencies f_{c}+k/T_{c}, k=0,1, . . . ,N−1 according to Costas sequence c(n).

One aspect of this structure is designing digital-to-analog (D/A) converters. Digital data enters at a rate 1/T to this unit and an amplitude modulated pulse train is generated at the output. If x_{d}(n) is the input of D/A the output is equal to:

$${x}_{b} ( t ) = {\sum }_{n} {x}_{d} ( n ) s ( t - nT ) \qquad ( 8 )$$

where s(t) is very low duration signal defined in equation (1). In a typical UWB-OFDM system T is around 10 nanoseconds and Ts is around nanoseconds. Then these D/As should operate around hundreds MHz. Sigma-Delta A/D and D/A converters are a good choice for high bit rate wireless communication. Traditional versions of sigma-delta modulators are not generally used in UWB-OFDM transceivers because they would typically require prohibitively high sampling rates. A modified sigma-delta modulator, the N-Tone sigma-delta modulator is described below which needs no over sampling and may be used for generating and receiving UWB-OFDM signals. The structure of N-Tone sigma-delta modulator is presented in the following section. A digital UWB-OFDM transmitter and receiver structure is described below based on this modulator.

N-Tone Sigma-Delta Modulator

Sigma-Delta modulation is an oversampling structure used for fast high-resolution analog-to-digital (A/D) and D/A converters. It digitizes the input signal to a low amplitude-resolution (usually 1 bit) but high time-resolution (oversampled) stream. FIG. 2 shows a discrete-time model of traditional Sigma-Delta modulator. The output of the integrator is digitized to a binary level (±V) and generates the output binary stream. While the loop contains a nonlinear part, its operation can be described using an approximate linear model of quantizer. The approximation yields an expression for the output of the sigma-delta modulator:

Y(z⁻¹)=X(z⁻¹)+(1−z⁻¹)E(z⁻¹) (9)

where x(n) is the input and y(n) is the output of the modulator. The quantization noise e(n) is filtered with H(z)=1−z⁻¹. According to equation (9) the sigma-delta structure filter introduces a zero in the spectrum of the quantization noise at f=0. If the input is a narrowband lowpass signal the amount of noise in the signal band is very small and most of the quantization noise is out of band and can be removed with proper lowpass filtering. To get better results, higher order sigma-delta modulators may be used in alternative embodiments of the invention.

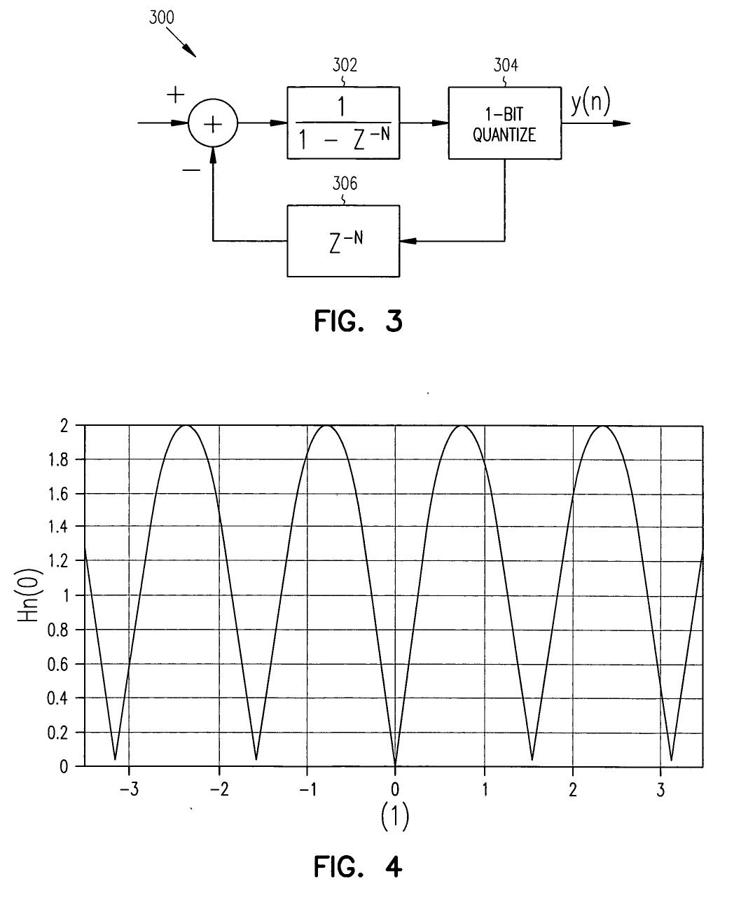

FIG. 3 shows the structure of an N-tone Sigma-Delta modulator 300 according to embodiments of the invention. In embodiments where an approximate linear model of the system is used, the output of the loop can be expressed as:

Y(z⁻¹)=X(z⁻¹)+(1−z^{-N})E(z⁻¹). (10)

The frequency response of quantization noise filter H(z)=(1−z^{-N}) is shown in FIG. 4. This new structure introduces zeros in frequencies 2πk/N k=0,1, . . . ,N−1 in noise spectrum and can be used for any signal that its spectrum mass is around this frequencies. Better filtering may be achieved using higher order N-Tone Sigma-Delta modulators. In order to use this structure for UWB-OFDM signals it may be desirable to leave gaps between sub-carrier frequencies where quantization noise is high. While this may be spectrally inefficient it does not need oversampling and leads to a simple transmitter structure. In equation (2), if one chooses f0=L/(NT) then the transmitted signal in the first symbol interval becomes:

$$x ( t ) = β {\sum }_{k = 1}^{K - 1} {b}_{k} p ( t ) {ⅇ}^{j \frac{2 π kt}{KT}} \qquad ( 11 )$$

where K=[N/L] is number of sub-carriers used for transmission data.

N-Tone Sigma-Delta UWB-OFDM Transmitter

The operation of the system may be illustrated with a QAM example. Similar structures can be used with the other types of modulation. FIG. (5A) illustrates a block diagram of an UWB-OFDM transmitter 500 using N-Tone sigma-delta modulator according to some embodiments of the invention. QAM symbols with rate R enter a serial to parallel converter 504 and are divided into N streams with rate R/N. Some embodiments insert L zeros between streams and compute an LN point IFFT 506 to generate an over sampled digital OFDM signal. By making a parallel to serial conversion 508 a digital OFDM signal with rate LR is obtained. Then the in-phase and quadrature components 509 are separated and applied to a N-tone sigma-delta modulator 510. The outputs of sigma delta modulators 510 are binary streams that carry OFDM signal plus noise. Some embodiments may filter them to remove quantization noise after doing D/A and send them to RF stage. In general, for non-average-power-constrained applications, some embodiments may skip this filtering stage and send the binary output of sigma-delta modulators using any single channel binary UWB system. Note that in this case the large peak to average power ratio (PAR) problem associated with OFDM systems may be eliminated. Specifically amplifiers need not have a large dynamic range as they process constant amplitude signals.

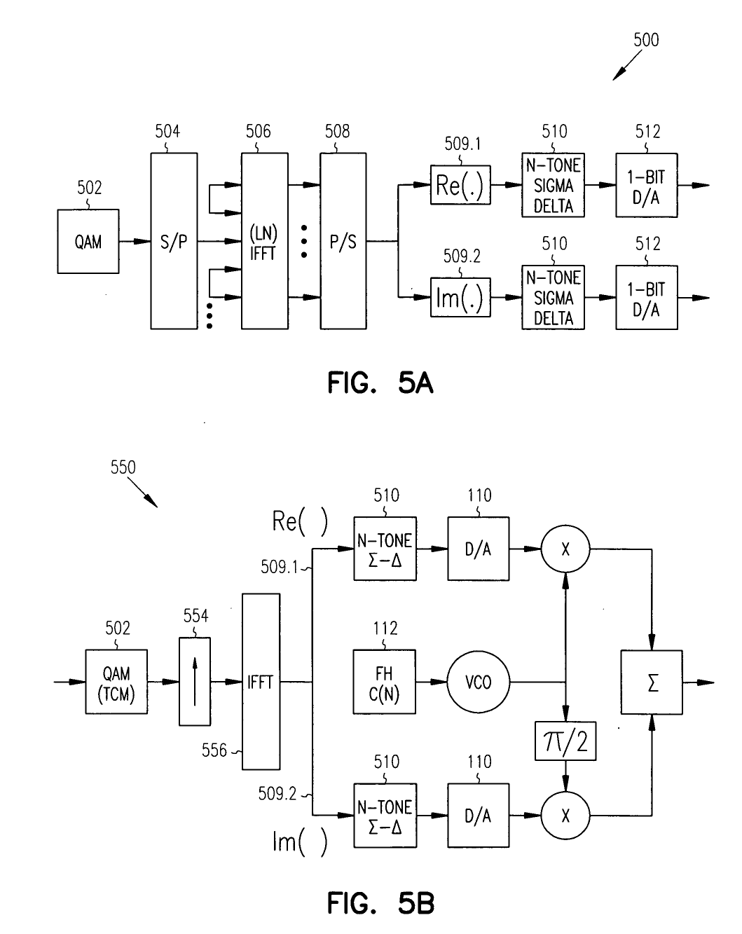

FIG. 5B is a block diagram illustrating the structure of an N-Tone Sigma-Delta UWB-OFDM transmitter according to alternative embodiments of the invention. Before OFDM modulation, the input QAM symbol stream is up-sampled by inserting L zeros after each symbol.

Consider a block of K QAM symbols as follows:

b(k)=bᵢ(k)+jb_{q}(k)k=0,1, . . . ,K−1. (12)

The corresponding output of up-sampler is a block of N=LK symbol equal to:

$${x}_{d} ( n ) = {\sum }_{i = 0}^{N - 1} d ( i ) {ⅇ}^{j \frac{2 π i n}{N}} = {\sum }_{k = 0}^{K - 1} b ( k ) {ⅇ}^{j \frac{2 π kn}{K}} n = 0 , 1 , … , N - 1. \qquad ( 14 )$$

If a digital IFFT operation is performed on this block, the output is equal to:

$$d ( i ) = \{ \begin{matrix}b ( k ) & i = kL \\ 0 & i \neq kL\end{matrix} i = 0 , 1 , … , K - 1. \qquad ( 13 )$$

If the input QAM symbols are equiprobable, the spectrum of x(n) is K separate lobes with gaps between them. The real and imaginary parts of x(n) pass through a N-Tone sigma-delta modulator 510. For the real part, according to the linear model of the sigma-delta modulator the output is equal to:

yᵢ(n)=x_{di}(n)+qᵢ(n) (15)

where qᵣ(n) is the quantization noise with a spectrum that lies within the gaps in the signal spectrum. The output yᵣ(n) is a binary signal that enters at a rate 1/T into a sample and hold unit, which holds its input for Tₛ and returns to zero. The output is an analog pulse train equal to:

$$\begin{matrix}{y}_{i} ( t ) = {\sum }_{n = 0}^{N - 1} {y}_{i} ( n ) s ( t - nT ) \\ = {x}_{i} ( t ) + {q}_{i} ( t ) .\end{matrix} \qquad ( 16 )$$

The same process accomplish on the imaginary part of x_{d}(n) to construct the quadrature baseband signal:

y_{q}(t)=x_{q}(t)+q_{q}(t). (17)

Frequency coding is applied in the RF stage by using carrier frequency hopping (FH) techniques 112 while modulating the base band signals in equations (16) and (17) with the carrier.

Peak To Average Power Ratio

One of the undesirable problems typically associated with OFDM systems is high peak to average power ratio (PAR). Since OFDM systems are sensitive to nonlinear distortion, designing a RF amplifier that operates linearly with high PAR signals is expensive. In some embodiments, N-Tone Sigma-Delta modulator addresses this problem at the expense of a portion of transmitted power. The outputs of Sigma-Delta D/As are binary streams that carry OFDM signal plus quantization noise. Some embodiments filter these signals properly to remove quantization noise before sending them to RF stage. For non-average-power-constrained applications, some embodiments may skip this filtering stage and send the binary output of the sigma-delta modulators to the RF stage. Note that in this case the large PAR problem may be substantially reduced or eliminated. Specifically amplifiers need not have a large dynamic range.

### Digital UWB-OFDM Receiver

Various embodiments of the invention comprise a receiver structure for receiving UWB-OFDM signals in a multipath fading channel. In some embodiments, these structures use a filter matched to the shaping pulse p(t). The output of this filter is sampled at the appropriate time instants and the resulting sampled are combined with the proper weights to form the decision statistics. Here, an alternative digital receiver structure 1-bit sigma-delta A/D is described.

Channel Model

A multipath fading channel is usually modeled as a random tapped-delay filter:

$$h ( t ) = {\sum }_{l = 0}^{L - 1} {α}_{l} δ ( t - {τ}_{l} ) \qquad ( 18 )$$

where L is the number of resolvable paths. According to this model there is a multipath reception at delay τₗ with random complex channel amplitude αₗ. The magnitudes |αₗ| are usually modeled as Rayleigh, Ricean, Nakagami-m, gamma or lognormal random variables. Assume that τₗ=lTᵣ, where Tᵣ=T_{c}/N[1]. Tᵣ can be on the order of a hundred picoseconds (3 cm path resolution) with pulse durations on the order of a few nanoseconds.

The received signal is equal to:

$$r ( t ) = {\sum }_{l = 0}^{L - 1} {α}_{l} y ( t - {τ}_{l} ) + n ( t ) \qquad ( 19 )$$

where n(t) is a zero-mean complex white Gaussian noise process of intensity N₀.

Receiver Structure

Recall that the goal of the receiver is to coherently combine as many multipaths as possible to minimize the bit error rate. Once more, it is desirable to perform the required calculations to the digital domain by properly using the N-tone sigma delta A/D converter. Before describing the resulting structure, let us treat first the simpler case in which there is only one path between the transmitter and receiver and the receiver has recovered timing information.

Single path receiver structure

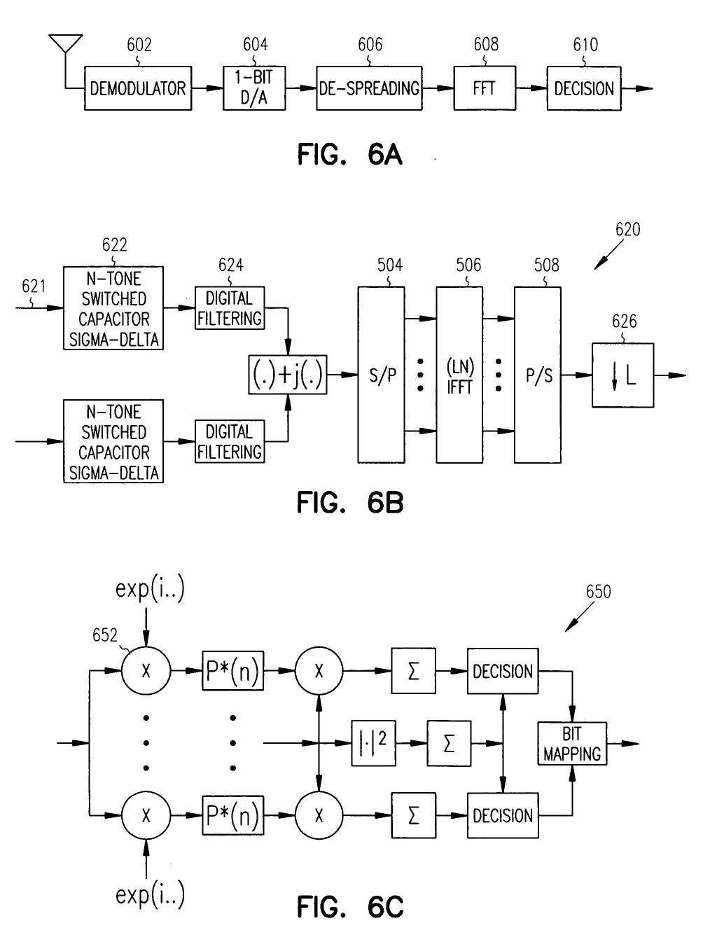

With appropriate timing information, the receiver may be implemented as a cascade of an analog RF demodulation stage, followed by a one bit N-tone sigma-delta A/D 604, despreading by multiplication by the signal m(t) 606, an FFT stage 608 and finally a decision 610 as shown in FIG. 6A. The one bit N-tone sigma-delta A/D has a structure identical to that of a one bit N-tone sigma-delta D/A as shown in FIG. 5B, except that it may be implemented using switched capacitors. As in the D/A case, higher order modulators will yield better results. Note that the FFT stage may serve a dual purpose. It helps convert the data from a single bit representation to a multi-bit representation. It also computes the coefficients bᵢ(k) and b_{q}(k).

Multipath receiver structure

FIG. 6B illustrates receiver structures for UWB-OFDM systems and method with multipath fading channels according to embodiments of the invention. For demodulation signals produced with N-Tone sigma-delta, observe first that one could attempt to detect the analog binary stream in analog domain and convert it to a binary digital stream. The digital stream then can be analyzed using an FFT to recover the data. The disadvantage of this approach is that it cannot exploit multipath effects to achieve more reliable detection. A different approach is to digitize the observation and use optimal or near optimal detection in the digital domain. Specifically some embodiments may use N-tone sigma-delta modulator 602 to implement a more digital receiver structure. FIG. 6B shows this structure. The input signal 601 is the transmitted signal plus noise that enters an analog version of N-Tone sigma-delta modulator. The output is an approximation of binary sequence generated at the receiver and some embodiments digitally filter 604 it to remove noise. The remaining process is like traditional OFDM and some embodiments downsample 610 the output to get transmitted symbols.

In the presence of multipath, some embodiments resolve each path separately. This can be done by modifying the structure described above as follows. Some embodiments forgo the de-spreading step since the de-spreading sequence needs to be synchronized to each path. Some embodiments then modify the FFT stage to incorporate de-spreading. Specifically, some embodiments implement that stage as a bank of filters with impulse response given by samples of exp(−j2πc(n)t/T_{c}) preceded by multiplication 652 of the input by samples of the subcarriers exp(−j2πkt/NT). The output of the filters are sampled at the appropriate delays, weighted by the gain of each multipath and added to form the decision variable as shown in FIG. 6B. This last step requires channel information and can either be implemented using a channel estimate obtained from training data or by using pilots.

### CONCLUSION

Systems and methods for transmitting and receiving UWB-OFDM signals using a sigma-delta modulator have been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The systems and methods of some embodiments provide advantages over previous systems. For example, an N-Tone sigma-delta modulator can be used for generating and receiving a subclass of UWB-OFDM signals. This procedure moves the bulk of the processing load from the analog section to the digital baseband section. The systems and methods of some embodiments are able to use inverse fast Fourier transform (IFFT) and fast Fourier transform (FFT) algorithms to generate and demodulate UWB-OFDM signals. Finally, the systems and methods of various embodiments address the high peak to average ratio (PAR) problem that typically occurs with OFDM systems.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

We claim:

1. A method for data communication comprising:
generating a train of a plurality of pulses; and
modulating the train of pulses using an N-tone Sigma-Delta modulator.
